(19) United States
(12) Patent Application Publication
(10) Pub. No.: US 2003/0007723 A1
(43) Pub. Date: Jan. 9, 2003

(54) Transmission system

(75) Inventors: Patrice Le Roux, Villebon Sur Yvette (FR); Laurent Labrunie, Paris (FR); Jean-Pierre Blondel, Buc (FR); Francois Boubal, Paris (FR); Laurence Buet, Paris (FR); Eric Brandon, Paris (FR); Vincent Havard, Choisy le Roi (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/188,085

(22) Filed: Jul. 3, 2002

(30) Foreign Application Priority Data
Jul. 5, 2001 (FR) 01 08 940

(51) Int. Cl. G02B 6/28; H04B 10/12

(52) U.S. Cl. 385/24; 359/173

(57) ABSTRACT

An optical fiber transmission system between a sender and a receiver of at least two signals with different wavelengths includes a line optical fiber and a pumping system for sending a pump signal into the line fiber to amplify the signals by distributed stimulated Raman scattering over an amplification length of the fiber. Gain equalization is applied in-line over the amplification length of the fiber so that the gain of each signal is close to the gain of the most strongly amplified signal, whereby each signal is amplified with substantially the same gain.

### CROSS-REFERENCE TO RELATED APPLICATIONS

This application is based on French Patent Application No. 01 08 940 filed Jul. 5, 2001, the disclosure of which is hereby incorporated by reference thereto in its entirety, and the priority of which is hereby claimed under 35 U.S.C. §119.

### BACKGROUND OF THE INVENTION

1. Field of the Invention

The invention relates to optical telecommunications. The invention relates especially to a transmission system provided with means for amplifying signals transported by an optical fiber.

2. Description of the Prior Art

Signals transporting data are usually wavelength division multiplexed (WDM) signals or dense wavelength division multiplexed (DWDM) signals transmitted simultaneously in the line optical fiber. This is known in the art. The WDM signals form a comb of separate but very closely spaced wavelengths (the spacing is of the order of 1 nanometer), usually in the C band (1 530 nm-1 560 nm) or the L band (1 565 nm-1 610 nm).

When WDM signals are transmitted over long distances by optical fibers, the signals are amplified, in particular to compensate their attenuation as they propagate in the line fiber. The signal amplification techniques available include optical amplification by Stimulated Raman Scattering (SRS). This technique produces optical amplification in the line fiber itself and/or widens the usable transmission bands of optical fiber networks. It increases the [capacity×distance] product of a link between terminals, for example, so that the range of a link can be extended or the transmission capacity increased.

Amplification by stimulated Raman scattering requires a pump to produce a pump signal which is generally a high-power signal at a wavelength from 1 400 nm to 1 500 nm. When injected into the line fiber, the pump signal propagates with the signals transporting the data on the line fiber.

Amplification by stimulated Raman scattering is used in links without optical repeaters, i.e. without optical amplifier systems including electrically active components. In links without optical repeaters, remote optical amplification by stimulated Raman scattering is applied by injecting the pump signal from a sender terminal or a receiver terminal.

Distributed amplification by stimulated Raman scattering is applied progressively over a portion of the length of the line fiber known as the amplification length. The pump signal injected into the line fiber provides a continuous and distributed supply of photons over the amplification length, which is the terminal portion of the fiber close to the receiver terminal, for example. For optical fibers with a silica core, the amplification length is typically several tens of kilometers.

The stimulated Raman scattering associated with this amplification technique is described in “Nonlinear Fiber Optics”, G. P. Agrawal, Academic Press, 1980. It is a nonlinear phenomenon of inelastic diffusion between light and matter. In outline, partial diffusion of the pump signal into the core of the line fiber causes rotation and vibration of the molecules of the core. This generates lines known as Stokes lines at wavelengths greater than that of the pump signal. The Stokes lines are continuously supplied with photons, with the result that they are reinforced by stimulated emission, and propagate in phase in a single propagation direction.

Consequently, the lines at the same wavelength as the WDM signals transported by the fiber are superposed on the WDM signals and amplify them. Amplification by stimulated Raman scattering is associated with a transfer of power between the pump signal and the WDM signals.

The higher the power of the pump signal, the greater the amplification of the signals, since the Raman gain is an increasing function of the power of the injected pump signal. However, in optical fiber transmission systems, amplification by stimulated Raman scattering becomes undesirable from an amplification threshold referred to as the critical amplification.

This limitation on the benefit of amplification by stimulated Raman scattering stems from Rayleigh scattering, as described by P. B. Hansen et al. in “Rayleigh scattering limitations in distributed Raman preamplifiers”, OFC'97 Technical Digest, FA2. Rayleigh scattering is also associated with an interaction between light and matter. In outline, a signal that passes through the core of a fiber is partly backscattered at each point of the optical fiber and the backscattered signal can itself be subject to backscattering, an effect which is known as double Rayleigh scattering (DRS). The wave that has undergone double Rayleigh scattering is recombined with the original optical signal.

The signal that has undergone double Rayleigh scattering is also amplified by stimulated Raman scattering over the amplification length.

Combining this kind of signal with a payload signal to be transmitted degrades optical transmission quality, to the point of possibly interrupting traffic if the critical amplification is reached. The Rayleigh backscattering coefficient of standard optical fiber is typically around −30 dB, so that the critical amplification is reached if the Raman amplification provides an optical grain greater than 30 dB, whereupon data transmission becomes impossible.

The Raman gain is a function of wavelength. It is therefore different for each WDM signal with a different wavelength. This is shown in FIG. 1, in which the curve 10 shows the characteristic profile of the Raman gain G at the input of a receiver terminal as a function of the wavelength×of the signals from 1 520 nm to 1 575 nm, with pumping at about 1 455 nm.

Amplification by stimulated Raman scattering is typically obtained by injecting into a standard fiber a pump signal with a power equal to approximately 1 W.

The variation of the Raman gain as a function of wavelength is reflected in a variation in the respective optical powers of the WDM signals at the input of the receiver terminal. Because the transmission quality of the WDM signals is proportional to their respective powers at the input of the receiver terminal, the WDM signals with the benefit of the greatest Raman amplification therefore have the best performance. The aim is therefore to have an optimum and flat gain over the whole of the WDM signal transmission band in order to have the benefit of an optimum transmission quality for all signals.

However, given the DRS problem referred to above, the most strongly amplified signal fixes the value of the pump power that cannot be exceeded without degrading or even cutting off signal transmission. Because of this, the most strongly amplified signal reaches an amplification closest to the critical amplification, but the other WDM signals of the transmission band are amplified less.

To level the gain curve and thereby obtain homogeneous transmission performance for all the WDM signals, one prior art solution is to place a passive component such as a gain equalization filter (GEF) at the input of the receiver terminal to introduce losses for each signal as a function of its wavelength.

The profile of the gain as a function of the wavelength λ between 1 520 nm and 1 575 nm obtained by this solution at the input of a receiver terminal with a GEF is shown in curve 20 in FIG. 2. Amplification is also obtained by injecting a pump signal with a power equal to 1 W at 1 455 nm on standard (G.652 or other type) fiber. FIG. 2 shows that the GEF makes the Raman amplification equal to the amplification of the least amplified C band signal, of wavelength 1 530 nm. A gain equal to approximately 21 dB is therefore induced over the whole of the pass-band. The most strongly amplified signal of wavelength 1 555 nm amplified by the Raman gain is therefore reduced from 30 dB to approximately 21 dB. This solution therefore cannot approximate the critical amplification.

A WDM transmission system using Raman amplification must therefore satisfy the following double constraint: a flat gain over the widest possible transmission band, and the greatest possible amplification as close as possible to the critical amplification.

An object of the invention is to provide a transmission system using Raman amplification and capable of achieving the highest possible level of amplification throughout the transmission band.

### SUMMARY OF THE INVENTION

To this end, the invention proposes an optical fiber transmission system between a sender and a receiver of at least two signals with different wavelengths, which system includes a line optical fiber, pumping means for sending into the line fiber a pump signal adapted to amplify the signals by distributed stimulated Raman scattering over an amplification length of the fiber, and gain equalizing means disposed in-line over the amplification length so that the gain of each signal is close to the gain of the most strongly amplified signal, whereby each signal is amplified with substantially the same gain.

In accordance with the invention, the gain equalizing means are disposed in-line over the amplification length and introduce losses as a function of wavelength. They therefore pass the signals least amplified by Raman amplification and attenuate the most strongly amplified signals sufficiently not to exceed the critical amplification.

Consequently, the gain equalizing means shift the power threshold DRS to a higher value so that it is possible to inject higher powers (up to 1 watt) than in the prior art solutions and obtain greater amplification, which can be close to the critical amplification, for all of the signals concerned.

Moreover, the gain in accordance with the invention is that over the whole of the pass-band and, unlike the prior art, this is not obtained by having the Raman gain equal to the gain of the least amplified signal, but to that of the signal most strongly amplified by Raman amplification.

Moreover, by using only one pump signal, the transmission system according to the invention increases the transmission band at low cost.

In one embodiment of the invention, the gain equalizer means can be passive.

In another embodiment of the invention, the gain equalizer means can be programmable.

This is possible using programs that compute the amplifier configurations in real time and adjust the parameters to obtain high and homogeneous amplification at all times.

The gain equalizer means according to the invention can preferably include a GEF.

In one embodiment of the invention, pumping means can be disposed at the receiver end.

In another embodiment of the invention, pumping means can be provided at the sender end.

According to the invention, the pump signal can be a contrapropagative or copropagative signal, i.e. coupled into the line fiber in the same direction as the payload signals or in the opposite direction.

In one embodiment of the invention, the transmission system can include an erbium-doped fiber section.

Optical fibers doped with rare earths and especially erbium are often used in the context of local erbium-doped fiber amplification (EDFA) of WDM signals.

In this latter embodiment, the erbium-doped fiber section can be remote, for example at a distance of several tens of kilometers from the sender or receiver.

It is advantageous for the transmission system according to the invention to insert into the line fiber a remote doped fiber section to provide remote EDFA amplification of WDM signals, in particular to increase the link distances without optical repeaters. Remote EDFA uses the pumping means of the invention in the vicinity of the receiver or sender. This amplification is referred to as “local” because it is carried out in the doped fiber, typically over a distance of several tens of meters.

For example, remote EDFA can be used to preamplify C band WDM signals by injecting a strong pump signal at 1 480 nm into the line fiber on the upstream side of the receiver. The higher the power of the pump signal at 1 480 nm, the better the performance of the EDFA (high gain) amplifiers and the greater the maximum distance from the doped fiber section to the receiver.

Raman amplification is also caused by the strong pump signal at 1 480 nm. The gain equalizing means according to the invention push back the critical amplification threshold and also filter noise at around 1 585 nm generated by Raman amplification. It is therefore possible to inject a more powerful clock signal (greater than 1 watt), which improves the performance of EDFA and Raman amplification and produces a flat signal gain at the input of the receiver.

The features and objects of the present invention will emerge from the following detailed description, which is given with reference to the accompanying drawings, which are provided by way of illustrative and nonlimiting example only.

### BRIEF DESCRIPTION OF THE DRAWINGS

FIG. 1 shows the characteristic profile of the Raman gain at the input of a receiver in a prior art system.

FIG. 2 shows the characteristic profile of the Raman gain and the profile of a Raman gain flattened by a GEF at the input of a receiver in a prior art system.

FIG. 3 is a diagrammatic view of a transmission system conforming to a first embodiment of the invention.

FIG. 4 represents the profile of a GEF of the FIG. 3 transmission system.

FIG. 5 shows the gain at the input of a receiver of the FIG. 3 transmission system.

FIG. 6 shows a transmission system conforming to a second embodiment of the invention.

### DETAILED DESCRIPTION OF THE PREFERRED EMBODIMENTS

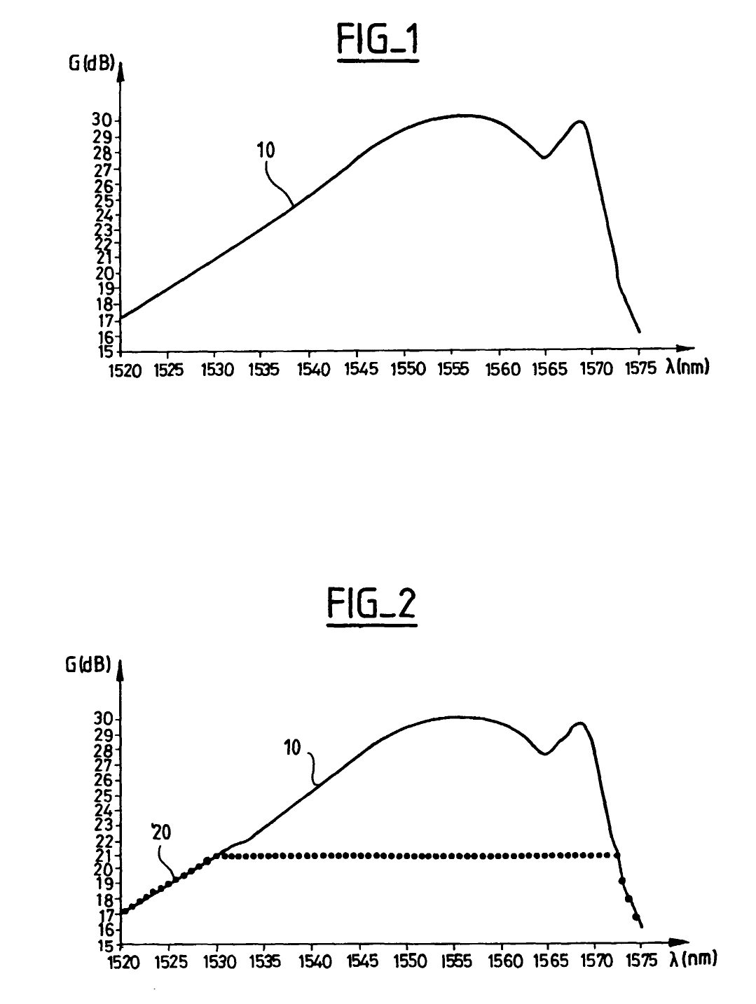

In all the figures, common elements are identified by the same reference numbers. FIGS. 1 and 2 have already been described in connection with the prior art.

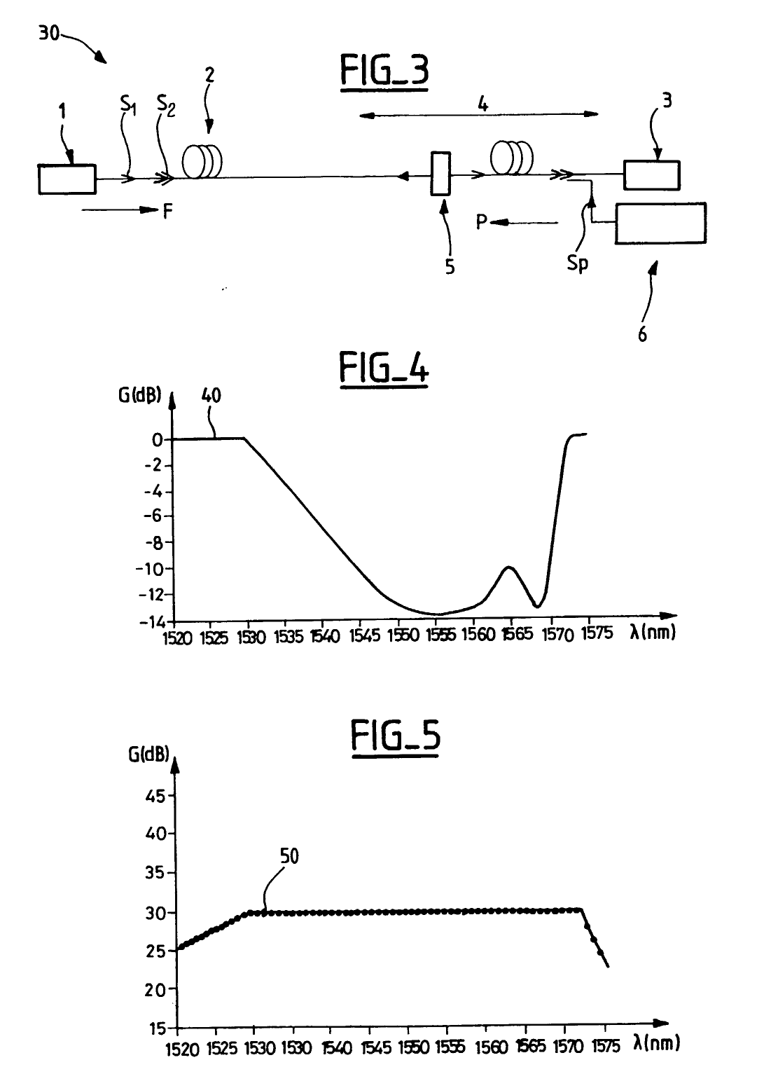

FIG. 3 shows a transmission system 30 conforming to a first embodiment of the invention and comprising a sender 1 and a receiver 3 connected by a line optical fiber 2 transmitting payload signals (signals transporting data) s₁ and s₂ with respective wavelengths λ₁ and λ₂ sent by the sender 1. The line optical fiber 2 is a monomode fiber, for example, such as a G.652 or G.654 fiber, and transmits WDM signals in the C band, for example. The arrow F in FIG. 3 shows the direction of propagation of the signals s₁ and s₂. The transmission system 30 further comprises a variable power (approximately 1 watt) pump laser 6 at the input of the receiver 3 and delivering continuously a pump signal sₚ with a wavelength close to 1 455 nm. The pump signal sₚ injected into the line fiber 2 is a contrapropagating signal because its signal propagation direction, represented by the arrow P, is opposite that of the signals s₁ and s₂. The pump signal sₚ is injected into the line fiber 2 from the receiver 3 by a device such as an optical circulator or a pump/WDM signal multiplexer (not shown).

According to the invention, the system 30 further comprises gain equalization means such as a GEF disposed on the line fiber 2 on the distributed Raman amplification length 4 between the sender 1 and the pump laser 6.

The transmission system 30 homogeneously and strongly amplifies by stimulated Raman scattering all of the WDM signals in the C band.

The Raman gain is known to depend on wavelength. For example, using the pump signal sₚ, the Raman gain, in the absence of the means 5, for a payload signal s₁ with a wavelength equal to 1 530 nm is less than the Raman gain for a payload signal s₂ with a wavelength equal to 1 555 nm.

The value of the injected power (approximately 1.75 W) is chosen so that the C band signals least strongly amplified by the Raman gain in the absence of the gain equalizing means 5 according to the invention can, thanks to the gain equalizing means 5, reach a level of amplification close to the critical amplification at the input of the receiver 3.

Thus the GEF 5 is placed in-line (i.e. on the transmission length of the line fiber 2) to equalize the Raman gain for the signals s₁ and s₂ at the input of the receiver 3 and to prevent the signal s₂ from being amplified beyond the critical amplification.

More generally, considering all the C band signals, the profile of the GEF 5 as a function of wavelength is similar to the inverted profile of the Raman gain (see FIG. 1) as shown by the curve 40 in FIG. 4.

The operation of the system 30 is explained in more detail next by describing the path of the signals s₁ and s₂.

The signal s₁ is sent by the sender 1 into the line fiber 2. The signal Si is amplified progressively by stimulated Raman scattering over the whole of the amplification length 4. As it propagates over the amplification length 4, the signal s₁ passes through the GEF 5, which allows it to pass because its amplification does not exceed the critical amplification.

The signal s₂ sent simultaneously into the line fiber 2 by the sender 1 is also amplified progressively by stimulated Raman scattering over the whole of the amplification length 4. However, as it propagates over the amplification length 4, the signal s₂ is attenuated by the GEF 5 so that its gain reaches but does not exceed a value as close as possible to the critical amplification at the receiver 3.

The curve 50 in FIG. 5 shows the profile of the gain G between 1 520 nm and 1 575 nm at the input of the receiver 3 of the transmission system 30.

A different embodiment of a transmission system according to the invention can combine remote EDFA for preamplification and stimulated Raman scattering amplification.

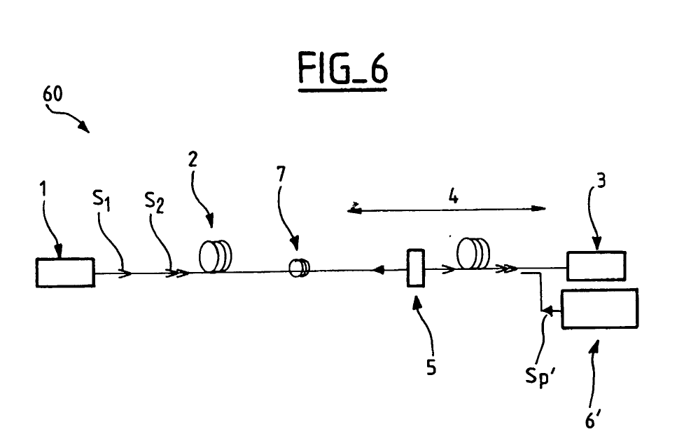

FIG. 6 shows a transmission system 60 conforming to a second embodiment of the invention. In addition to the components 1, 2, 3, 4 and 5 of the system 30, the system 60 includes a pump laser 6′ of variable power (approximately 1 watt) between the receiver 3 and the line fiber 2 delivering continuously a pump signal s_{p′} at a wavelength close to 1 480 nm. An erbium-doped optical fiber section 7 is inserted into the line fiber 2 in order to provide EDFA for preamplification. The pump signal sp is injected into the line fiber 2 from the receiver 3 by a device such as an optical circulator or a pump/WDM signal multiplexer (not shown).

The transmission system 60 strongly amplifies all C band WDM signals in the fiber 7 and then by stimulated Raman scattering in the line fiber 2.

Accordingly, the gain equalizing means 5 are placed in-line to equalize the Raman gain for the signals s₁ and s₂ at the input of the receiver 3 and to prevent the signal s₂ from being amplified beyond the critical amplification. The means 5 also filter the noise at around 1 585 nm generated by the Raman amplification.

The signal s₁ is sent by the sender 1 into the line fiber 2. The signal s₁ is first preamplified locally, i.e. over a distance of a few tens of meters, when it travels through the section of erbium-doped optical fiber 7 pumped remotely by the pump laser 6′. The signal s₁ is then progressively amplified in the line fiber 2 by stimulated Raman scattering over the whole of the amplification length 4. As it propagates over the amplification length 4, the signal s₁ passes through the GEF 5 which allows it to pass if its amplification does not exceed the critical amplification.

The signal S2 sent simultaneously by the sender 1 into the line fiber 2 is also preamplified in the erbium-doped optical fiber section 7 and is then amplified by stimulated Raman scattering over the whole of the amplification length 4. As it propagates over the amplification length 4, this signal s₂ is attenuated by the GEF 5 which thereby limits its gain to a value as close as possible to the critical amplification.

Of course, the preceding description has been given by way of purely illustrative example only. Any means can be replaced by equivalent means without departing from the scope of the invention.

In particular, the transmission system according to the invention can include optical repeaters or regenerators or not.

The profile and location of the gain equalizing means, the nature of the line fiber and that of the doped fiber can also vary as a function of the required amplification.

The system according to the invention can also transmit signals in bands other than the C band and the L band, in which case the wavelength of the pump signal is chosen accordingly.

There is claimed:

1. An optical fiber transmission system between a sender and a receiver of at least two signals with different wavelengths, which system includes a line optical fiber, pumping means for sending into said line fiber a pump signal adapted to amplify said signals by distributed stimulated Raman scattering over an amplification length of said fiber, and gain equalizing means disposed in-line over said amplification length so that the gain of each signal is close to the gain of the most strongly amplified signal, whereby each signal is amplified with substantially the same gain.

2. The transmission system claimed in claim 1 wherein said gain equalizing means are passive.

3. The transmission system claimed in claim 1 wherein said gain equalizing means are programmable.

4. The transmission system claimed in claim 1 wherein said gain equalizing means include a GEF.

5. The transmission system claimed in claim 1 wherein said pumping means are at the receiver end.

6. The transmission system claimed in claim 1 wherein said pumping means are at the sender end.

7. The transmission system claimed in claim 1 wherein said pump signal is a contrapropagating signal.

8. The transmission system claimed in claim 1 wherein said pump signal is a copropagating signal.

9. The transmission system claimed in claim 1 including an erbium-doped fiber section.

10. The transmission system claimed in claim 9 wherein said erbium-doped fiber section is remote.
